(19) United States
(12) Patent Application Publication
(10) Pub. No.: US 2020/0115868 A1
(43) Pub. Date: Apr. 16, 2020

(54) Hybrid water filtering cleaning and quality monitoring device

(71) Applicant: Remora Incorporated, San Juan, PR (US)

(72) Inventors: Andrea Curet, Caguas, PR (US); Ben Markoch, Raleigh, NC (US); Omar J. Negron, Corozal, PR (US); Sunny Su, Raleigh, NC (US)

(73) Assignee: Remora Incorporated, San Juan, PR (US)

(21) Appl. No.: 16/597,717

(22) Filed: Oct. 9, 2019

Related U.S. Application Data
(60) Provisional application No. 62/744,076, filed on Oct. 10, 2018.

(51) Int. Cl. E02B 15/04; C02F 1/00

(52) U.S. Cl. CPC E02B 15/046; C02F 2103/007; C02F 2303/04; C02F 1/004

(57) ABSTRACT

A hybrid water filtering cleaning and quality monitoring device integrates multiple elements into one main system, including oil filtering, bacterial management, trash collection and water quality monitoring.

### CROSS-REFERENCE TO RELATED APPLICATIONS

This application claims priority on the provisional patent application No. 62/44,076 filed on Oct. 10, 2018; as established on 35 U.S.C. § 119(e).

### BACKGROUND OF THE INVENTION

The goal of the device is to clean water in a particular area over time, allowing communities to become independent of outside-aid and temporary “band-aid” solutions like water bottles and life straws. It also allows local governments to get snapshot of water quality being processed by the machine.

### BRIEF SUMMARY OF THE INVENTION

The device is an easily portable, easy-to-install water filtration device that allows communities to take direct and immediate action when it comes to cleaning their most important water sources. The invention works by cleaning water at its source, rather than after it has been transported or by transporting the filtered water.

### BRIEF DESCRIPTION OF THE SEVERAL VIEWS OF THE DRAWING

FIG. 1 shows the side-view of the embodiment.

FIG. 2 shows the back-view of the embodiment.

FIG. 3 shows exemplary fields of application and uses of the embodiment.

FIG. 4 shows a top-view of the embodiment.

FIG. 5 shows another side-view of the embodiment.

FIG. 6 shows an earlier prototype of the embodiment.

FIG. 7 shows a top view of an embodiment of the invention.

FIG. 8 shows a bottom view of an embodiment of the invention.

FIG. 9 shows a front elevation view of an embodiment of the invention.

FIG. 10 shows a back elevation view of an embodiment of the invention.

FIG. 11 shows a right elevation view of an embodiment of the invention.

FIG. 12 shows a left elevation view of an embodiment of the invention.

FIG. 13 shows an isometric view of an embodiment of the invention.

### DETAILED DESCRIPTION OF THE INVENTION

Water purifiers absorb polluted water out of natural water courses and exports said liquid onto a different container. The machine works by, on the same place, filtering small debris, chemicals, and other biohazard from localities like rivers, ponds, lakes and streams. This allows the purification of water to be easier to manage and obtain by eliminating the requirement of a clean water storage container. This disclosure integrates multiple elements into one main system such as: oil filtering, bacterial management, and water quality monitoring. It works with a hybrid filtering system to adapt to every kind of water source; using an active filtering system in calm water sources and a passive filtering system in vivid water sources.

Typically, this mechanism requires larger equipment and a group of specialized human assistance, while the present invention simplifies the task; moreover, the invention's functionality and quality can be monitored remotely. The embodiment features an easily portable and to install water filtration device by cleaning water at its source, rather than after it has been transported. As described below.

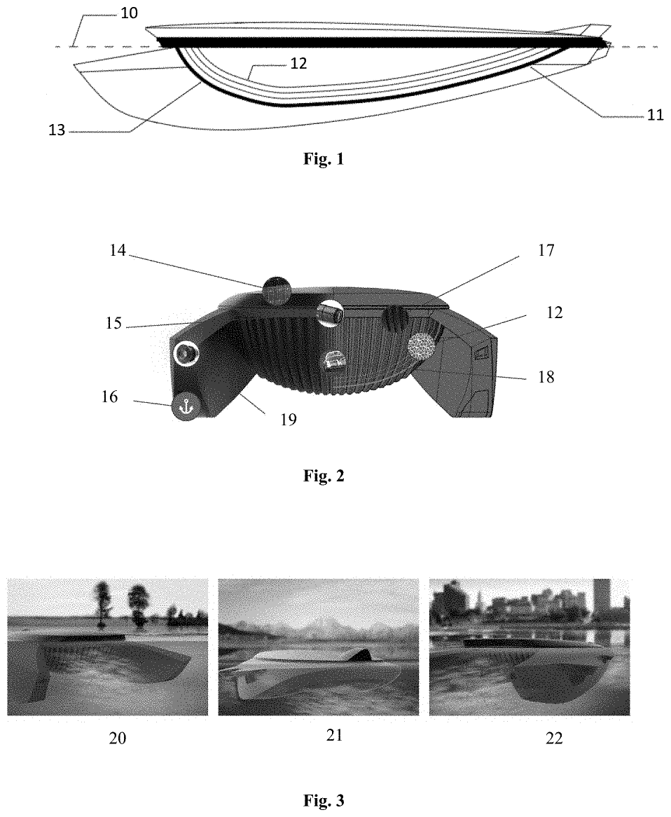

Referring to FIG. 1, shown is an embodiment in which 10 demonstrates the water level that it is positioned to receive polluted water by intake 11 and pass it through gradient density filters 12 that eliminate chemicals, bacteria, biohazard, and microplastics, in order to produce clean water outtake 13.

Referring to FIG. 2, a back-view of the embodiment, shows that the body contains flexible solar panels 14 which contour to its' shape and provide constant and renewable power; a front sensor GPS and radio/controller rear sensors and camera 15 to monitor water quality and provide visual feedback; and a retractable anchor 16 to allow it to stay in the water. This is all part of a corrugated shell 17 which prevents overly-large debris from clogging the gradient density filters 12 which may vary in size. It is powered by a high-efficiency engine 18 which relies on auto-adjusting speed for intake and outtake which allows the appropriate amount of water to be filtered without clogging. Finally, it has an LED light 19 for visual performance indication.

Referring to FIG. 3, shows exemplary fields of application and uses here disclosed. The embodiment can, but is not limited to, the use in swamp or low-country 20 by being tethered to a tree, other stationary object or to solid earth and removing slime and chemical build up. It can also be used in lakes or estuaries 21 by anchoring to the lake bed which allows it to function with minimal movement and also removes harmful bacteria. It is also promoted its use in rivers and streams 22 in which it can be tethered to any fixed object and can help remove debris without harming wildlife.

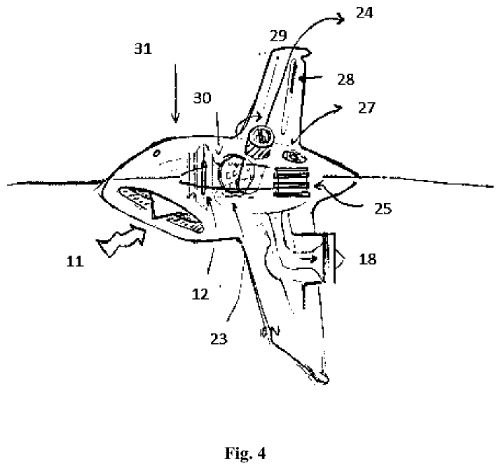

Referring to FIG. 4, a top-view of the embodiment, an intake channel 11 receives water which proceeds to pass through organic filters 12 and decontamination cells 23, as well as a filter which removes biohazard waste 24 and culture chambers 25; all of this is powered by an engine 18. The outside of the invention includes a buoyancy valve 27 and reflector 28. From the top-view, the right side of the invention possesses an antenna 29 and stabilizer fin 30.

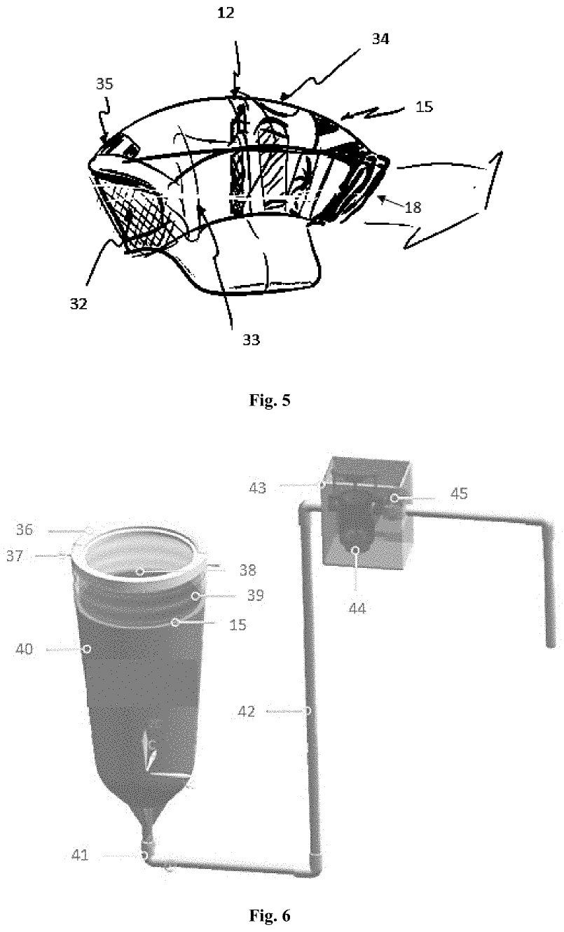

Referring to FIG. 5, a side-view of the embodiment, water enters through the left side, where it first is filtered by a grate 32 to block larger organisms. It proceeds to pass through a capture system 33 and a filter 12 collecting large organic matter, followed by another filter 34 to siphon microbial lifeforms. Finally, an engine 18 propels the machine. The invention also contains a front sensor GPS 35 and radio/controller rear sensors 15.

Referring to FIG. 6, an earlier prototype of the apparatus consisting of a plastic ring 36 above an aluminum ring 37. Inside is a mesh bag 38 connected to a flex foam tube 39 and Arduino sensors 15. This is connected to an aluminum tube 40. This body leads to PVC connectors 41 and PVC tubes 42 which lead to PVC panels secure box 43, comprising an oil filter 44 and water pump 45.

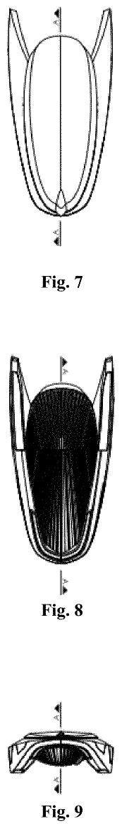

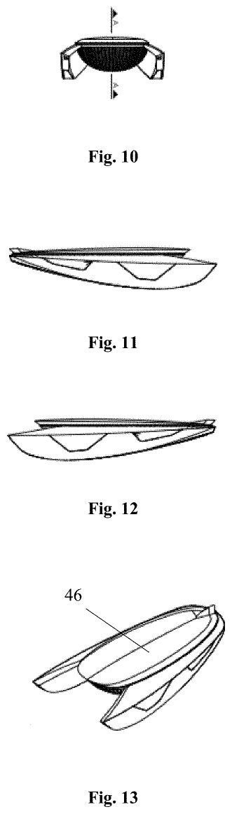

FIGS. 7-12 show several different views of the embodiment.

Referring to FIG. 13, an isometric view of the embodiment, shows the top of the embodiment which has a lid 46 that can be opened to easily access the inside machinery.

1. A water filtration machine comprising:
a floating body comprising a water intake port, an antenna, and a stabilizer fin;
a filter;
a GPS;
a solar panel;
a battery;
an electric engine capable of automatically adjusting its operating speed;
a retractable anchor;
an LED light; and
a propulsion system.

2. A water filtration machine as recited by claim 1, wherein said filter comprises a plurality of gradient densities.

5. A water filtration machine as recited by claim 1, wherein said anchor is configured to be tied or tethered to a tree.

6. A water filtration machine as recited by claim 1, wherein said anchor is configured to be tied or tethered to the bottom of a body of water.

7. A water filtration machine as recited by claim 1, wherein said anchor is configured to be tied or tethered to any stationary object.

8. A water filtration machine comprising:
a floating body,
an electric engine that activates the filter system, which also generates a propulsion system that is mainly powered by a battery that is charged by a solar panel,
a filter;
a GPS, an antenna and a LED light that indicates the machine's filter condition, and
an anchor that maintains the machine steady in a water body system.
